(19) United States
(12) Patent Application Publication
(10) Pub. No.: US 2024/0309536 A1
(43) Pub. Date: Sep. 19, 2024

(54) METHOD FOR PRODUCING METAL NANOWIRE, METAL NANOWIRE, DISPERSION LIQUID, AND CONDUCTIVE FILM

(71) Applicant: FUJIFILM Corporation, Tokyo (JP)

(72) Inventors: Shunji KUROOKA, Shizuoka (JP); Kazuto SHIMADA, Haibara-gun (JP); Yuichi KASUYA, Haibara-gun (JP)

(73) Assignee: FUJIFILM Corporation, Tokyo (JP)

(21) Appl. No.: 18/674,541

(22) Filed: May 24, 2024

Related U.S. Application Data
(63) Continuation of application No. PCT/JP2022/046873, filed on Dec. 20, 2022.

(30) Foreign Application Priority Data
Jan. 21, 2022 (JP) 2022-007742
Jun. 28, 2022 (JP) 2022-103451

(51) Int. Cl. C25D 11/18; B82Y 40/00; H01B 1/02; H01B 13/00

(52) U.S. Cl. CPC C25D 11/18; B82Y 40/00; H01B 1/02; H01B 13/0006; H01B 13/0036

(57) ABSTRACT

An object of the present invention is to provide a method for producing a metal nanowire, which makes it possible to obtain a metal nanowire with a low connection resistance; a metal nanowire; a dispersion liquid; and a conductive film. The method for producing a metal nanowire of an embodiment of the present invention includes an anodization step of forming an anodized film having pores on a surface of a valve metal substrate, a metal filling step of filling the pores with a metal, a mold removing step of removing the anodized film and the valve metal substrate to obtain an acicular metal, and a protective layer forming step of forming a protective layer containing a corrosion inhibitor on the acicular metal.

### CROSS-REFERENCE TO RELATED APPLICATIONS

This application is a Continuation of PCT International Application No. PCT/JP2022/046873 filed on Dec. 20, 2022, which claims priority under 35 U.S.C. § 119(a) to Japanese Patent Application No. 2022-007742 filed on Jan. 21, 2022 and Japanese Patent Application No. 2022-103451 filed on Jun. 28, 2022. The above applications are hereby expressly incorporated by reference, in their entirety, into the present application.

### BACKGROUND OF THE INVENTION

### 1. Field of the Invention

The present invention relates to a method for producing a metal nanowire, a metal nanowire, a dispersion liquid, and a conductive film.

### 2. Description in the related art

In recent years, various studies have been attempted on conductive materials using metal nanowires or metal nanopillars.

It is already known that porous alumina is used as a template in the manufacture of nanomaterials as such a conductive material. For example, JP2012-238592A describes a method in which an aluminum substrate is subjected to an anodization treatment, an aluminum base material removing treatment, a penetration treatment, a metal filling treatment, and an anodized film removing treatment in this order to obtain a metal nanowire (0025 and [FIG. 1]).

### SUMMARY OF THE INVENTION

The present inventors have conducted studies on the metal nanowire described in JP2012-238592A, and as a result, they have revealed that there is room for improvement in connection resistance.

Therefore, an object of the present invention is to provide a method for producing a metal nanowire, which makes it possible to obtain a metal nanowire with a low connection resistance; a metal nanowire; a dispersion liquid; and a conductive film.

The present inventors have conducted intensive studies to accomplish the object, and as a result, they have found that a metal nanowire with a low connection resistance can be obtained by removing an anodized film and a valve metal substrate to recover an acicular metal, and then forming a protective layer containing a corrosion inhibitor, thereby completing the present invention.

That is, the present inventors have found that the object can be accomplished by the following configurations.

[1] A method for producing a metal nanowire, the method comprising:
an anodization step of forming an anodized film having pores on a surface of a valve metal substrate;
a metal filling step of filling the pores with a metal;
a mold removing step of removing the anodized film and the valve metal substrate to obtain an acicular metal; and
a protective layer forming step of forming a protective layer containing a corrosion inhibitor on the acicular metal.

[2] The method for producing a metal nanowire according to [1], further comprising, between the mold removing step and the protective layer forming step:
a step of reducing or removing a surface oxide layer of the acicular metal.

[3] The method for producing a metal nanowire according to [1] or [2],
in which the valve metal substrate includes aluminum.

[4] The method for producing a metal nanowire according to any one of [1] to [3],
in which the metal filling step includes a plating step.

[5] The method for producing a metal nanowire according to any one of [1] to [4],
in which the mold removing step includes a two-stage removal step of removing the valve metal substrate and then removing the anodized film.

[6] The method for producing a metal nanowire according to any one of [1] to [5],
in which the mold removing step includes a dissolution step.

[7] The method for producing a metal nanowire according to any one of [1] to [6],
in which filling with the metal in the metal filling step is a treatment performed on a region from a bottom of the pore to a middle of an opening portion out of an entire region from the bottom of the pore to the opening portion.

[8] The method for producing a metal nanowire according to any one of [1] to [7],
in which the corrosion inhibitor includes a heterocyclic compound containing at least one of a nitrogen atom or a sulfur atom.

[9] The method for producing a metal nanowire according to any one of [1] to [8],
in which the corrosion inhibitor includes at least one of a polar group-containing acid or a polar group-containing base.

[10] The method for producing a metal nanowire according to any one of [1] to [9],
in which the corrosion inhibitor includes a carboxy group.

[11] A metal nanowire comprising:
an acicular metal; and
a protective layer covering at least a part of the acicular metal,
in which the protective layer contains a corrosion inhibitor.

[12] A dispersion liquid comprising:
the metal nanowire according to [11].

[13] The dispersion liquid according to [12],
in which the dispersion liquid is used in a conductive ink application.

[14] A conductive film formed of the dispersion liquid according to or [13].

[15] The conductive film according to [14],
in which the conductive film is used in a transparent conductive film application.

According to the present invention, it is possible to provide a method for producing a metal nanowire, which makes it possible to obtain a metal nanowire with a low connection resistance; a metal nanowire; a dispersion liquid; and a conductive film.

### BRIEF DESCRIPTION OF THE DRAWINGS

FIG. 1A is a schematic cross-sectional view of a valve metal substrate before an anodization step in a procedure showing an example of a method for producing a metal nanowire of an embodiment of the present invention.

FIG. 1B is a schematic cross-sectional view of a structure after an anodization step in a procedure showing an example of the method for producing a metal nanowire of the embodiment of the present invention.

FIG. 1C is a schematic cross-sectional view of a structure after a metal filling step in a procedure showing an example of the method for producing a metal nanowire of the embodiment of the present invention.

FIG. 1D is a schematic cross-sectional view of a structure after a mold removing step in a procedure showing an example of the method for producing a metal nanowire of the embodiment of the present invention.

FIG. 1E is a schematic cross-sectional view of a structure (metal nanowire) after a protective layer forming step in a procedure showing an example of the method for producing a metal nanowire of the embodiment of the present invention.

### DESCRIPTION OF THE PREFERRED EMBODIMENTS

Hereinafter the present invention will be described in detail.

Descriptions on the constitutional requirements which will be described later are made based on representative embodiments of the present invention in some cases, but it should not be construed that the present invention is limited to such embodiments.

Furthermore, in the present specification, a numerical range expressed using “to” means a range including numerical values before and after “to” as a lower limit value and an upper limit value.

### Method for Producing Metal Nanowire

The method for producing a metal nanowire (hereinafter also simply referred to as a “production method of the embodiment of the present invention”) of the embodiment of the present invention has an anodization step of forming an anodized film having pores on a surface of a valve metal substrate, a metal filling step of filling the pores with a metal, a mold removing step in which the anodized film and the valve metal substrate are removed to obtain an acicular metal, and a protective layer formation step of forming a protective layer containing a corrosion inhibitor on the acicular metal.

In the present invention, a metal nanowire with a low connection resistance can be obtained by removing the anodized film and the valve metal substrate to recover the acicular metal (after the mold removing step), and then forming a protective layer containing a corrosion inhibitor, as described above.

Here, a reason why the metal nanowire with a low connection resistance can be obtained is not clear in detail, but is presumed to be as follows.

That is, it is considered that an oxide film can be prevented from being formed on a surface of the acicular metal by providing a protective layer containing a corrosion inhibitor on the acicular metal, and therefore, the connection resistance can be maintained at a low level.

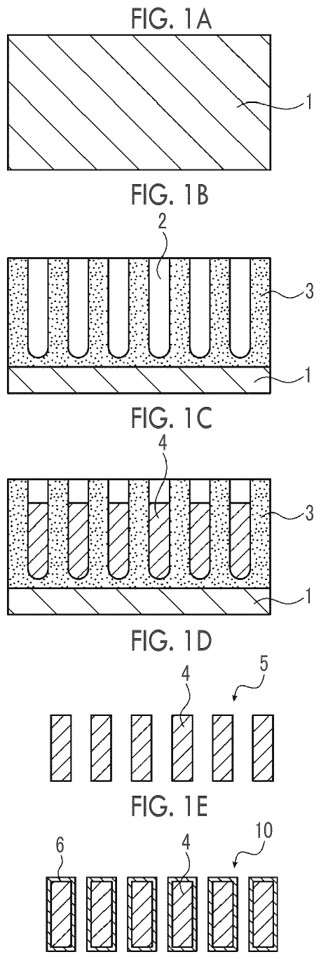

Next, after an outline of each step in the production method of the embodiment of the present invention is described with reference to FIGS. 1A to 1E, each treatment step will be described in detail.

As shown in FIGS. 1A and 1B, in the anodization step, a surface of a valve metal substrate 1 is subjected to an anodization treatment to form an anodized film 3 having pores (micropores) 2 on a surface of the valve metal substrate 1.

Next, as shown in FIG. 1C, in the metal filling step, the pores 2 are filled with a metal 4.

Next, as shown in FIG. 1D, in the mold removing step, the anodized film 3 and the valve metal substrate 1 are removed to obtain an acicular metal 5.

Next, as shown in FIG. 1E, in the protective layer forming step, a metal nanowire 10 in which a protective layer 6 containing a corrosion inhibitor is formed on the acicular metal 5 can be obtained.

### Valve Metal Substrate

The valve metal substrate used in the production method of the embodiment of the present invention is not particularly limited as long as it is a substrate containing a valve metal.

Here, specific examples of the valve metal include aluminum, tantalum, niobium, titanium, hafnium, zirconium, zinc, tungsten, bismuth, and antimony. Among these, aluminum is preferable since it has good dimensional stability and is relatively inexpensive.

Therefore, in the production method of the embodiment of the present invention, a substrate including aluminum (hereinafter simply referred to as an “aluminum substrate”) is preferably used as the valve metal substrate.

The aluminum substrate is not particularly limited, and specific examples thereof include a pure aluminum plate; an alloy plate having aluminum as a main component and including a trace amount of foreign elements; a substrate obtained by vapor-depositing high-purity aluminum on low-purity aluminum (for example, a recycled material); a substrate obtained by covering a surface of a silicon wafer, quartz, glass, or the like with high-purity aluminum by a method such as vapor deposition, sputtering, or the like; and a resin substrate laminated with aluminum.

A surface of the aluminum substrate on a side to be subjected to an anodization treatment in an anodization step which will be described preferably has an aluminum purity of 99.5% by mass or more, more preferably 99.9% by mass or more, and still more preferably 99.99% by mass or more. In a case where the aluminum purity is within the above-described range, the regularity of the arrangement of through-passes is sufficient.

In addition, it is preferable that the surface of the aluminum substrate on the side to be subjected to the anodization treatment in the anodization step which will be described below is preferably subjected to a heat treatment, a degreasing treatment, and a mirror finishing treatment in advance.

Here, with regard to the heat treatment, the degreasing treatment, and the mirror finishing treatment, the same treatment as each of those described in paragraphs [0044] to [0054] of JP2008-270158A can be carried out.

### Anodization Step

The anodization step is a step of subjecting a surface of the valve metal substrate to an anodization treatment to form an anodized film having pores on the surface of the valve metal substrate.

For the anodization treatment performed in the anodization step, a well-known method in the related art can be used. However, for a reason that an acicular metal having a small variation in diameter can be obtained in the mold removing step which will be described later, it is preferable that a self-regulation method or a constant voltage treatment is used.

Here, with regard to the self-regulation method or the constant voltage treatment for the anodization treatment, the same treatments as those described in paragraphs [0056] to [0108] and [FIG. 3] of JP2008-270158A can be carried out.

For the anodization treatment, for example, a method in which a valve metal substrate is electrically energized as an anode in a solution at an acid concentration of 1% to 10% by mass can be used.

As the solution that is used for the anodization treatment, an acid solution is preferable, and sulfuric acid, phosphoric acid, chromic acid, oxalic acid, sulfamic acid, benzenesulfonic acid, amidosulfonic acid, glycolic acid, tartaric acid, malic acid, or citric acid is more preferable, among which sulfuric acid, phosphoric acid, or oxalic acid is still more preferable, and oxalic acid is particularly preferable. These acids may be used alone or in combination of two or more kinds thereof.

The conditions for the anodization treatment cannot be sweepingly determined since they change depending on an electrolytic solution to be used; however, in general, the conditions of the anodization treatment are preferably conditions in which the electrolytic solution concentration is 0.1% to 20% by mass, the liquid temperature is −10° C. to 30° C., the current density is 0.01 to 20 A/dm², the voltage is 3 to 300 V, and the electrolysis time is 0.5 to 30 hours, more preferably conditions in which the electrolytic solution concentration is 0.5% to 15% by mass, the liquid temperature is −5° C. to 25° C., the current density is 0.05 to 15 A/dm², the voltage is 5 to 250 V, and the electrolysis time is 1 to 25 hours, and still more preferably conditions in which the electrolytic solution concentration is 1% to 10% by mass, the liquid temperature is 0° C. to 20° C., the current density is 0.1 to 10 A/dm², the voltage is 10 to 200 V, and the electrolysis time is 2 to 20 hours.

The treatment time for the anodization treatment is preferably 0.5 minutes to 16 hours, more preferably 1 minute to 12 hours, and still more preferably 2 minutes to 8 hours.

A thickness of the anodized film formed by the anodization step is not particularly limited, but is preferably 0.3 to 300 μm, more preferably 0.5 to 120 μm, and still more preferably 0.5 to 100 μm from the viewpoint of adjusting the length of the metal nanowire.

Furthermore, in order to measure the thickness of the anodized film, the anodized film is cut in the thickness direction with focused ion beams (FIB), and a surface photograph (magnification: 50,000 times) of a cross-section thereof is taken with a field emission scanning electron microscope (FE-SEM). Thus, the thickness can be calculated as an average value measured at 10 points.

A density of the pores formed by the anodization step is not particularly limited, but is preferably 2,000,000 pores/mm² or more, more preferably 10,000,000 pores/mm² or more, still more preferably 50,000,000 pores/mm² or more, and particularly preferably 100 million pores/mm² or more.

Furthermore, the density of the pores was measured and calculated by the method described in paragraphs [0168] and [0169] of JP2008-270158A.

An average opening diameter of the pores formed by the anodization step is not particularly limited; but is preferably 5 to 500 nm, more preferably 20 to 400 nm, still more preferably 40 to 200 nm, and particularly preferably 50 to 100 nm from the viewpoint of adjusting the diameter of the metal nanowire.

Furthermore, a surface photograph (magnification: 50,000 times) was taken with FE-SEM, and thus, the average opening diameter of the pores can be calculated as an average value of the values measured at 50 points.

### Metal Filling Step

The metal filling step is a step of filling the inside of the pores with a metal after the anodization step.

### <Metal>

The metal is preferably a material having an electrical resistivity of 10³ Ω·cm or less, and suitable specific examples thereof include gold (Au), silver (Ag), copper (Cu), aluminum (Al), magnesium (Mg), nickel (Ni), zinc (Zn), and cobalt (Co).

Among those, from the viewpoint of the electrical conductivity, Cu, Au, Al, Ni, or Co is preferable, Cu, Ni, or Co is more preferable, and Cu is still more preferable.

### <Filling Method>

Examples of the method for filling the inside of the pores with the metal include the same methods as those described in paragraphs [0123] to [0126] and [FIG. 4] of JP2008-270158A.

In the production method of the embodiment of the present invention, for a reason that it is difficult for a cavity portion to be included in the manufactured metal nanowire, it is preferable that the metal filling step includes a plating step.

Specifically, an electrolytic plating treatment method is preferably used as the method in which the inside of the pores is filled with the metal, and for example, an electrolytic plating method or an electroless plating method can be used.

Here, it is difficult to selectively precipitate (grow) a metal in a hole with a high aspect by an electrolytic plating method known in the related art, which is used for coloration and the like. This is presumed to be due to a fact that the precipitated metal is consumed in the hole, and thus the plating does not proceed even in a case where electrolysis is carried out for a constant period time or longer.

Therefore, in the production method of the embodiment of the present invention, in a case where a metal is used for filling by the electrolytic plating method, it is necessary to allow a rest time during pulse electrolysis or constant potential electrolysis. A rest time of 10 seconds or more is required, and the rest time is preferably 30 to 60 seconds.

In addition, it is also desirable to additionally apply ultrasonic waves to promote the stirring of the electrolytic solution.

Furthermore, the electrolytic voltage is usually 20 V or less, and desirably 10 V or less, but it is preferable that a precipitation potential of a target metal in an electrolytic solution to be used in advance is measured and constant potential electrolysis is performed within the potential +1 V. Incidentally, in a case of performing the constant potential electrolysis, it is desirable that cyclic voltammetry can be used in combination, and a potentiostat device from Solartron Analytical, BAS Inc., HOKUTO DENKO Corporation, IVIUM Technologies B. V., or the like can be used.

As the plating solution, a plating solution known in the related art can be used.

Specifically, an aqueous copper sulfate solution is generally used for precipitating copper, but a concentration of copper sulfate is preferably 1 to 300 g/L, and more preferably 100 to 200 g/L. In addition, the precipitation can be promoted by adding hydrochloric acid to the electrolytic solution. In this case, the concentration of hydrochloric acid is preferably 10 to 20 g/L.

In addition, in a case of precipitating gold, it is desirable that a sulfuric acid solution of tetrachloroaurate is used and the plating is performed by alternating current electrolysis. Furthermore, in the electroless plating method, it takes a long time to fully fill a hole consisting of pores with a high aspect, and it is thus desirable to fill the hole with a metal by the electrolytic plating method in the production method of the embodiment of the present invention.

In the production method of the embodiment of the present invention, a treatment method in which an alternating current electrolytic plating method and a direct current electrolytic plating method are combined in this order is preferably used as the electrolytic plating treatment method.

Here, in the alternating current electrolytic plating method, for example, a voltage is applied after sinusoidal modulation at a predetermined frequency. Furthermore, a waveform during the modulation of the voltage is not limited to a sine wave, and can be, for example, a rectangular wave, a triangular wave, a sawtooth wave, or a reverse sawtooth wave.

In addition, the treatment method in the electrolytic plating method described above can be appropriately used for the direct current electrolytic plating method.

In the production method of the embodiment of the present invention, for a reason that the time for producing a metal nanowire can be shortened, it is preferable that filling with the metal in the metal filling step is a treatment performed on a region from a bottom of the pore to a middle of an opening portion out of the entire region from the bottom of the pore to the opening portion, as shown in FIG. 1C.

### Plate Removing Step

The mold removing step is a step of removing the anodized film and the valve metal substrate after the metal filling step to obtain an acicular metal.

In the production method of the embodiment of the present invention, a method for removing the anodized film and the valve metal substrate is not particularly limited, and it may be, for example, an aspect in which the removal is carried out by polishing. However, for a reason that the length of the manufactured metal nanowire is uniform, it is preferable that the mold removing step includes a dissolution step, that is, at least a part of the anodized film or the valve metal substrate is removed by a dissolution treatment.

In the production method of the embodiment of the present invention, for a reason that the shape or the size of the manufactured metal nanowire is maintained, it is preferable that the mold removing step includes a two-stage step in which the valve metal substrate is removed, and then the anodized film is removed, and it is more preferable that the removal steps at both the stages are steps involving removal by the dissolution treatment.

### <Removal of Valve Metal Substrate>

For the removal of the valve metal substrate, a dissolution treatment using a treatment liquid that is difficult to dissolve the anodized film and easily dissolves the valve metal is preferable.

In such a treatment liquid, the dissolution rate for the valve metal is preferably 1 μm/min or more, more preferably 3 μm/min or more, and still more preferably 5 μm/min or more. Similarly, the dissolution rate for the anodized film is preferably 0.1 nm/min or less, more preferably 0.05 nm/min or less, and still more preferably 0.01 nm/min or less.

Specifically, the treatment liquid is preferably a treatment liquid including at least one metal compound having an ionization tendency lower than that of the valve metal and having a pH of 4 or less or 8 or more. The pH of the treatment liquid is more preferably 3 or less or 9 or more and still more preferably 2 or less or 10 or more.

Such a treatment liquid is preferably a treatment liquid obtained by blending, for example, manganese, zinc, chromium, iron, cadmium, cobalt, nickel, tin, lead, antimony, bismuth, copper, mercury, silver, palladium, platinum, a gold compound (for example, chloroplatinic acid), fluorides of these metals, and chlorides of these metals, based on an aqueous acid or alkali solution.

Among those, an aqueous acid solution-based treatment liquid is preferable, and a chloride blend is preferably blended.

In particular, a treatment liquid obtained by blending mercury chloride with an aqueous hydrochloric acid solution (hydrochloric acid/mercuric chloride) or a treatment liquid obtained by blending copper chloride with an aqueous hydrochloric acid solution (hydrochloric acid/copper chloride) is preferable from the viewpoint of a treatment latitude.

Furthermore, the composition of such a treatment liquid is not particularly limited, and for example, a bromine/methanol mixture or a bromine/ethanol mixture can be used.

In addition, the concentration of the acid or the alkali of such a treatment liquid is preferably 0.01 to 10 mol/L, and more preferably 0.05 to 5 mol/L.

Furthermore, the treatment temperature at which such a treatment liquid is used is preferably −10° C. to 80° C., and more preferably 0° C. to 60° C.

In addition, the removal of the valve metal substrate is performed by bringing the valve metal substrate after the metal filling step into contact with the above-described treatment liquid. The contact method is not particularly limited, and examples thereof include a dipping method and a spraying method. Among these, the dipping method is preferable. The contact time in this case is preferably 10 seconds to 5 hours, and more preferably 1 minute to 3 hours.

### <Removal of Anodized Film>

For the removal of the anodized film, a solvent that does not dissolve the metal filled in the pores but selectively dissolves the anodized film can be used, and either an aqueous alkali solution or an aqueous acid solution can be used.

Here, in a case where the aqueous alkali solution is used, it is preferable to use an aqueous solution of at least one alkali selected from the group consisting of sodium hydroxide, potassium hydroxide, and lithium hydroxide, and it is more preferable to use the aqueous solution of potassium hydroxide. In addition, the concentration of the aqueous alkali solution is preferably 0.1% to 5% by mass. The temperature of the aqueous alkali solution is preferably 10° C. to 60° C., more preferably 15° C. to 45° C., and still more preferably 20° C. to 35° C.

On the other hand, in a case where the aqueous acid solution is used, it is preferable to use an aqueous solution of an inorganic acid such as chromic acid, sulfuric acid, phosphoric acid, nitric acid, hydrochloric acid, or oxalic acid, or an aqueous solution of a mixture of these, and it is more preferable to use the aqueous solution of chromic acid. In addition, the concentration of the aqueous acid solution is preferably 1% to 10% by mass. The temperature at the aqueous acid solution is preferably 15° C. to 80° C., more preferably 20° C. to 60° C., and still more preferably 30° C. to 50° C.

In addition, the removal of the anodized film is performed by bringing the anodized film into contact with the above-described aqueous alkaline solution and the above-described aqueous acid solution after the metal filling step (preferably after removing the valve metal substrate). The contact method is not particularly limited, and examples thereof include a dipping method and a spraying method. Among these, the dipping method is preferable. The time of immersion in the aqueous alkali solution and the aqueous acid solution is preferably 5 to 120 minutes, more preferably 8 to 120 minutes, still more preferably 8 to 90 minutes, and particularly preferably 10 to 90 minutes. Among these, the time is preferably 10 to 60 minutes, and more preferably 15 to 60 minutes.

A method for recovering the acicular metal in the mold removing step is not particularly limited, but the acicular metal can be recovered by removing the anodized film and the valve metal substrate, and then performing a separation operation such as filtration using a filter or the like, and centrifugation.

### Protective Layer Forming Step

The protective layer forming step is a step of forming a protective layer containing a corrosion inhibitor on the acicular metal after the mold removing step.

The corrosion inhibitor is not particularly limited and a known corrosion inhibitor can be applied.

Examples of the corrosion inhibitor include a compound containing at least one of a nitrogen atom, an oxygen atom, or a sulfur atom.

From the viewpoint of durability, the corrosion inhibitor is preferably a heterocyclic compound containing at least one of a nitrogen atom or an oxygen atom, more preferably a compound including a 5-membered ring structure containing one or more nitrogen atoms, and particularly preferably at least one compound selected from the group consisting of a compound including a triazole structure, a compound including a benzimidazole structure, and a compound including a thiadiazole structure. The 5-membered ring structure containing one or more nitrogen atoms may be a monocyclic structure or a partial structure constituting a fused ring.

In addition, for a reason that the corrosion inhibitor is easily adsorbed on the surface of the acicular metal, it is preferable that the corrosion inhibitor is a compound including at least one of a polar group-containing acid or a polar group-containing base.

Examples of the polar group contained in the polar group-containing acid and the polar group-containing base include a carboxylic acid group (carboxy group), a sulfonic acid group (sulfo group), a phosphonic acid group, a phosphoric acid group, primary to quaternary ammonium bases, a carboxylate group, a sulfonate group, a phosphonate group, and a phosphate group.

In addition, the corrosion inhibitor is preferably a compound including a carboxy group for a reason that it is bonded with a metal ion to form a complex ion and the surface of the acicular metal is easily protected.

Specific examples of the corrosion inhibitor include imidazole, benzimidazole, 1,2,4-triazole, benzotriazole (BTA), tolyltriazole (TTA), butylbenzyltriazole, alkyldithiothiadiazole, alkylthiol, 2-aminopyrimidine, 5,6-dimethylbenzimidazole, 2-amino-5-mercapto-1,3,4-thiadiazole, 2,5-dimercapto-1,3,4-thiadiazole (DMTDA), 2-mercaptopyrimidine, 2-mercaptobenzoxazole, 2-mercaptobenzothiazole (MBT), and 2-mercaptobenzimidazole.

Other specific examples of the corrosion inhibitor include aliphatic carboxylic acids such as acetic acid, propionic acid, palmitic acid, stearic acid, lauric acid, arachidic acid, terephthalic acid, and oleic acid; carboxylic acids such as glycolic acid, lactic acid, oxalic acid, malic acid, tartaric acid, and citric acid; aminopolycarboxylic acids such as ethylenediaminetetraacetic acid (EDTA), nitrilotriacetic acid (NTA), iminodiacetic acid (IDA), ethylenediaminediacetic acid (EDDA), and ethylene glycol diethyl ether diaminetetraacetic acid (GEDA); uric acid; and gallic acid.

The corrosion inhibitors may be used alone or in appropriate combination of two or more kinds thereof.

In addition, for a reason that the temporal stability is improved, it is preferable that the corrosion inhibitor includes a compound containing a nitrogen atom (nitrogen-containing compound), it is more preferable that the corrosion inhibitor is a nitrogen-containing compound, and it is still more preferable that the corrosion inhibitor is a heterocyclic compound containing at least one of a nitrogen atom or a sulfur atom.

A method for forming a protective layer containing such a corrosion inhibitor is not particularly limited, and examples thereof include a method in which an acicular metal recovered in the mold removing step is added to an aqueous solution containing a corrosion inhibitor, and the solution is stirred; and a method in which a corrosion inhibitor is added to a washing solvent for washing the acicular metal recovered in the mold removing step.

### Reduction or Removal Step

For a reason that a metal nanowire having lower connection resistance can be obtained, it is preferable that the production method of the embodiment of the present invention further includes a step of reducing or removing a surface oxidation layer of the acicular metal between the mold removing step and the protective layer forming step.

Examples of the reduction or removal step include a step of performing an immersion treatment using the aqueous alkali solution and the aqueous acid solution in the treatment for removing the anodized film described above.

### Metal Nanowire

The metal nanowire of the embodiment of the present invention has an acicular metal and a protective layer covering at least a part of the acicular metal.

In addition, in the metal nanowire of the embodiment of the present invention, the protective layer contains a corrosion inhibitor.

### Acicular Metal

The acicular metal contained in the metal nanowire of the embodiment of the present invention is not particularly limited as long as it is an acicular structure (core material) consisting of a metal.

Examples of the metal include those described in the metal filling step in the above-described production method of the embodiment of the present invention.

In the present invention, the average length of the acicular metal is not particularly limited, but is preferably 0.2 to 200 μm, more preferably 0.2 to 100 μm, and still more preferably 0.3 to 80 μm.

In addition, the average diameter of the acicular metal is not particularly limited, but for a reason that the metal nanowire can be suitably used in the formation of a transparent conductive film, the average diameter is preferably 5 to 500 nm, more preferably 20 to 400 nm, still more preferably 40 to 200 nm, and particularly preferably 50 to 100 nm.

Furthermore, the average length and the average diameter of the acicular metal are calculated as an average value obtained by observing 300 metal nanowires with FE-SEM, and measuring the length and the diameter of the acicular metal excluding the protective layer.

In the present invention, for a reason that the entanglement of the metal nanowires is suppressed and the dispersion stability of the dispersion liquid of an embodiment of the present invention which will be described later is improved, a ratio (length/diameter) of the length to the diameter (hereinafter also simply referred to as an “aspect ratio”) of the acicular metal is preferably 10 or more, more preferably 10 to 2,000, and still more preferably 12 to 1,000.

### Protective Layer

The protective layer contained in the metal nanowire of the embodiment of the present invention is a protective layer covering at least a part of the acicular metal, in which the protective layer contains a corrosion inhibitor.

Examples of the corrosion inhibitor include those described in the protective layer forming step in the above-described production method of the embodiment of the present invention.

In the present invention, an average thickness of the protective layer is not particularly limited, but is preferably 0.1 to 10 nm, and more preferably 1 to 5 nm.

### Dispersion Liquid

The dispersion liquid of the embodiment of the present invention is a dispersion liquid containing the above-described metal nanowire of the embodiment of the present invention.

Here, a content (concentration) of the metal nanowires in the dispersion liquid of the embodiment of the present invention is not particularly limited, but for a reason that the dispersion stability over time is favorably maintained and the uniformity at the time of dilution is also improved, the content is preferably 0.1% to 30% by mass, and more preferably 0.1% to 25% by mass with respect to a total mass of the dispersion liquid.

### Dispersion Solvent

As the dispersion solvent in the dispersion liquid of the embodiment of the present invention, water is mainly used, and an organic solvent that is miscible with water can be used in combination at a proportion of 80% by volume or less.

As the organic solvent, for example, an alcohol-based compound having a boiling point of 50° C. to 250° C., more preferably 55° C. to 200° C. is suitably used. By using such an alcohol-based compound in combination, the application in the coating step during the formation of the conductive film can be improved and the drying load can be reduced.

The alcohol-based compound is not particularly limited, and is appropriately selected depending on the intended purpose. Specific examples thereof include polyethylene glycol, polypropylene glycol, alkylene glycol, and glycerol. These may be used alone or in combination of two or more kinds thereof.

Specific examples thereof include compounds with a small number of carbon atoms, such as ethylene glycol diethylene glycol, 1,2-propanediol, 1,3-propanediol, 1,2-butanediol, 1,3-butanediol, 1,4-butanediol, and 2,3-butanediol, having a low viscosity at room temperature, is preferable, but a compound with a large number of carbon atoms, such as pentanediol, hexanediol, octanediol, and polyethylene glycol, can also be used.

Among those, the most preferred solvent is diethylene glycol.

### Surfactant

In the dispersion liquid of the embodiment of the present invention, it is preferable that a surfactant is used for a reason that the dispersion stability is further improved.

Examples of the surfactant include a nonionic surfactant, an anionic surfactant, a cationic surfactant, an amphoteric surfactant, and a fluorine-based surfactant, and these may be used alone or in combination of two or more kinds thereof.

The nonionic surfactant is not particularly limited and a nonionic surfactant known in the related art can be used.

Examples thereof include polyoxyethylene alkyl ethers, polyoxyethylene alkylphenyl ethers, polyoxyethylene-polystyryl phenyl ethers, polyoxyethylene-polyoxypropylene alkyl ethers, partial fatty acid esters of glycerol, partial fatty acid esters of sorbitan, partial fatty acid esters of pentaerythritol, monoesters of fatty acids with propylene glycol, partial fatty acid esters of sucrose, partial fatty acid esters of polyoxyethylene sorbitan, partial fatty acid esters of polyoxyethylene-sorbitol, polyethylene glycol fatty acid esters, partial fatty acid esters of polyglycerol, polyoxyethylated castor oils, partial fatty acid esters of polyoxyethylene glycerol, fatty acid diethanolamides, N,N-bis-2-hydroxyalkylamines, polyoxyethylene alkylamines, triethanolamine fatty acid esters, trialkylamine oxides, polyethylene glycol (for example, polyethylene glycol monostearate), and copolymers of polyethylene glycol and polypropylene glycol.

The anionic surfactant is not particularly limited and an anionic surfactant known in the related art can be used.

Examples thereof include fatty acid salts, abietic acid salts, hydroxyalkanesulfonic acid salts, alkanesulfonic acid salts, dialkylsulfosuccinic acid salts, (linear alkyl)benzenesulfonic acid salts, (branched alkyl)benzenesulfonic acid salts, alkylnaphthalenesulfonic acid salts, alkylphenoxypolyoxyethylenepropylsulfonic acid salts, polyoxyethylene alkylsulfophenyl ether salts, N-methyl-N-oleyltaurine sodium salt, N-alkylsulfosuccinic acid monoamide disodium salts, petroleumsulfonic acid salts, sulfonated tallow oil, sulfuric acid ester salts of fatty acid alkyl esters, alkylsulfuric acid ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkylphosphoric acid ester salts, polyoxyethylene alkyl ether phosphoric acid ester salts, polyoxyethylene alkylphenyl ether phosphoric acid ester salts, partially saponified styrene/maleic anhydride copolymers, partially saponified olefin/maleic anhydride copolymers, and naphthalenesulfonic acid salt/formalin condensates.

The cationic surfactant is not particularly limited and a cationic surfactant known in the related art can be used. Examples thereof include alkylamine salts, quaternary ammonium salts, polyoxyethylene alkylamine salts, and polyethylene polyamine derivatives.

The amphoteric surfactant is not particularly limited and an amphoteric surfactant known in the related art can be used. Examples thereof include carboxybetaines, aminocarboxylic acids, sulfobetaines, aminosulfuric acid esters, and imidazoline compounds.

Furthermore, among the surfactants, “polyoxyethylene” can be replaced by “polyoxyalkylene” such as polyoxymethylene, polyoxypropylene, and polyoxybutylene, and these surfactants also can be used in the present invention.

In the present invention, preferred examples of the surfactant include a fluorine-based surfactant containing a perfluoroalkyl group in the molecule.

Examples of such a fluorine-based surfactant include anionic-types such as perfluoroalkanecarboxylic acid salts, perfluoroalkanesulfonic acid salts, and perfluoroalkylphosphoric acid esters; amphoteric-types such as perfluoroalkyl betaines; cationic-types such as perfluoroalkyltrimethylammonium salts; and nonionic-types such as perfluoroalkylamine oxides, perfluoroalkyl ethylene oxide adducts, oligomers having a perfluoroalkyl group and a hydrophilic group, oligomers having a perfluoroalkyl group and an oleophilic group, oligomers having a perfluoroalkyl group, a hydrophilic group, and an oleophilic group, and urethanes having a perfluoroalkyl group and an oleophilic group. In addition, the fluorine-based surfactants described in JP1987-170950A (JP-S62-170950A), JP1987-226143A (JP-S62-226143A), and JP1985-168144A (JP-S60-168144A) are also suitable.

In addition, in the present invention, for a reason that the dispersion stability is further improved, among those surfactants, the surfactant having an HLB value of 10 or more is desirably used.

Here, the HLB value (hydrophile-lipophile balance) is a value representing a degree of affinity of a surfactant for water and an oil (organic compound insoluble in water). The HLB value takes a value from 0 to 20. As the value is closer to 0, the lipophilicity is higher, and as the value is closer to 20, the hydrophilicity is higher.

In the present invention, these surfactants may be used alone or in combination of two or more kinds thereof.

In addition, a content of the surfactant is preferably 0.001% to 10% by mass, and more preferably 0.01% to 5% by mass with respect to the total mass of the metal nanowire.

### Inorganic Glass Component

For the dispersion liquid of the embodiment of the present invention, it is preferable to use an inorganic glass component including at least one element selected from the group consisting of silicon, lithium, boron, and phosphorus for a reason that not only the affinity to water or another solvent serving as a dispersion solvent is maintained, but also the film quality of a conductive film to be formed of the dispersion liquid of the embodiment of the present invention is improved.

As the inorganic glass component, for example, a raw material component such as silicic acid glass, borate glass, phosphoric acid glass, and lithium salt glass, that is, sodium silicate, sodium borate, sodium phosphate, a metal oxide salt, or the like can be used. Specific examples thereof include a No. 3 aqueous Na silicate solution, Na borate (NaBO₃), Li nitrate, and sodium dihydrogen phosphate.

### Water-Soluble Dispersant

For the dispersion liquid of the embodiment of the present invention, in a case where Au nanowires or metal nanowires coated with Au are dispersed, a water-soluble organic molecule having a hydroxyl group, a carboxyl group, a sulfone group, a phosphoric acid group, an amino group, an SH group, or the like at the terminal, for example, a water-soluble dispersant such as succinic acid, polyvinyl alcohol (PVA), and polyvinyl pyrrole (PVP) can be used.

For example, with a use of an organic substance having an SH group, in a case where a dispersion liquid in which metal nanowires are dispersed in an aqueous solution and a water-insoluble liquid including a water-insoluble dispersant are mixed, the water-insoluble dispersant having a high affinity SH group can be adsorbed onto a surface of Au nanowires, the Au nanowires can be efficiently moved to the water-insoluble fraction, thus facilitating separation and concentration.

Here, the organic substance having an SH group is not particularly limited as long as it is dissolved in a water-insoluble liquid, but in a case where the organic substance is a short molecular organic substances with a low vaporization temperature, it can be blown off by a heat treatment such as sintering.

Examples of such a low-molecular-weight organic substance include 1-octanethiol and 2-furylmethanethiol.

In addition, for example, in a case where a solvent including an organic substance having an SH group is added to an aqueous gold nanowire dispersion solution, heated, stirred, and then centrifuged, and the solvent fraction is recovered, the Au nanowire component is concentrated and the solvent is removed by evaporation to perform redispersion, thereby making it possible to prepare a dispersion liquid having a desired concentration.

### Conductive Particles

The dispersion liquid of the embodiment of the present invention may further contain conductive particles other than the metal nanowire.

Here, the conductive particles preferably include a metal, and more preferably include at least one metal selected from the group consisting of gold, silver, copper, aluminum, nickel, zinc, and cobalt.

In addition, the conductive particles may include one kind or two or more kinds of conductive components other than a metal.

In the present invention, the shape of the conductive particles is not particularly limited, and may be solid or hollow.

Furthermore, an average major axis of the conductive particles in a minimum enclosing ellipsoid is preferably 0.01 μm or more and 50 μm or less.

In addition, the average major axis of the conductive particles in the minimum enclosing ellipsoid is preferably 1 to 10 times the average minor axis of the conductive particles.

Here, the minimum enclosing ellipsoid refers to an ellipsoid having the smallest volume among the ellipsoids including the conductive particles inside, and also includes an ellipsoid of which major axis and minor axis coincide (that is, a sphere).

In addition, the average major axis of the minimum bounding ellipsoid can be determined by observing a cross-section of a layer formed of the dispersion liquid in the thickness direction with a microscope (for example, an electron microscope), measuring the major axes of 100 particles to obtain an arithmetic mean value. Similarly, the average minor axis of the minimum bounding ellipsoid can be determined by observing a cross-section of a layer formed of the dispersion liquid in the thickness direction with a microscope (for example, an electron microscope), measuring the minor axes of 100 particles to obtain an arithmetic mean value.

Furthermore, a median diameter (D50) which will be described later refers to a median diameter of diameters in a case where the volume of the conductive particles is approximated to a sphere, and can be determined using a laser diffraction or scattering method or a dynamic light scattering method.

In the present invention, a content of the conductive particles in a case where the conductive particles are contained is not particularly limited, but the content is preferably 5 to 70 parts by mass, and more preferably 10 to 45 parts by mass with respect to 100 parts by mass of the metal nanowire.

The dispersion liquid of the embodiment of the present invention can be suitably used as a conductive ink that forms a circuit pattern of a wiring board.

In a case of being used as a conductive ink, the content (concentration) of the metal nanowires in the dispersion liquid of the embodiment of the present invention is preferably 10% to 30% by mass, and more preferably 15% to 20% by mass for a reason that a circuit pattern can be printed by using an ink jet method.

### Conductive Film

The conductive film of an embodiment of the present invention is a conductive film formed of the above-described dispersion liquid according to the embodiment of the present invention.

Here, the conductive film is a concept including not only a film formed on the entire surface of a desired substrate surface but also the above-described circuit pattern and the like.

In addition, a substrate that forms the conductive film or a method for forming the conductive film is not particularly limited, and for example, the substrate or the forming method described in JP2010-84173A can be adopted.

In the conductive film of the embodiment of the present invention, for a reason that a balance between the conductivity and the permeability is excellent, the content of the metal nanowire is preferably 0.005 to 1 g per m², and more preferably 0.01 to 0.1 g per m².

The conductive film of the embodiment of the present invention can be suitably used as, for example, a transparent conductive film used for a touch panel, an antistatic material for a display, an electromagnetic wave shield, an electrode for an organic or inorganic EL display, electronic paper, an electrode for a flexible display, an antistatic material for a flexible display, an electrode for a solar cell, and various other devices.

### EXAMPLES

Hereinafter, the present invention will be described in more detail with reference to Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be restrictively interpreted by the following Examples.

### Example 1

### <Production of Aluminum Substrate>

A molten metal was prepared using an aluminum alloy containing 0.06% by mass of Si, 0.30% by mass of Fe, 0.005% by mass of Cu, 0.001% by mass of Mn, 0.001% by mass of Mg, 0.001% by mass of Zn, and 0.03% by mass of Ti, and as a balance, Al and unavoidable impurities. The molten metal was subjected to a molten metal treatment and filtration, and then an ingot with a thickness of 500 mm and a width of 1,200 mm was manufactured according to a direct chill (DC) casting method.

Next, the surface was scraped off using a surface grinder to an average thickness of 10 mm, then soaked and held at 550° C. for about 5 hours, and the temperature was lowered to 400° C., thereby obtaining a rolled plate with a thickness of 2.7 mm, using a hot rolling mill.

Furthermore, the rolled plate was subjected to a heat treatment at 500° C. using a continuous annealing machine, and then subjected to cold rolling to be finished to a thickness of 1.0 mm, thereby obtaining an aluminum substrate in accordance to Japanese Industrial Standards (JIS) 1050 Material.

The aluminum substrate was formed into a wafer shape with a diameter of 200 mm (8 inches) and then subjected to each of the following treatments.

### <Electropolishing Treatment>

The above-described aluminum substrate was subjected to an electropolishing treatment using an electropolishing liquid having the following composition under the conditions of a voltage of 25 V, a liquid temperature of 65° C., and a liquid flow rate of 3.0 m/min.

A carbon electrode was used as a cathode and GP0110-30R (manufactured by TAKASAGO Ltd.) was used as a power source. In addition, a flow rate of the electrolytic solution was measured using a vortex flow monitor FLM22-10PCW (manufactured by AS ONE Corporation).

### (Composition of Electropolishing Liquid)

| | |
|---|---|
| 85% by mass of phosphoric acid (reagent manufactured | 660 mL |
| by FUJIFILM Wako Pure Chemical Corporation) | |
| Pure water | 160 mL |
| Sulfuric acid | 150 mL |
| Ethylene glycol | 30 mL |

### <Anodization Step>

Next, the aluminum substrate after the electropolishing treatment was subjected to an anodization treatment by a self-regulation method according to the procedure described in JP2007-204802A.

The aluminum substrate after the electropolishing treatment was subjected to a pre-anodization treatment for 5 hours using an electrolytic solution of 0.50 mol/L oxalic acid under conditions of a voltage of 40 V, a liquid temperature of 16° C., and a liquid flow rate of 3.0 m/min.

Next, the aluminum substrate subjected to the pre-anodization treatment was immersed for 12 hours in a mixed aqueous solution (liquid temperature: 50° C.) of 0.2 mol/L of chromic acid anhydride and 0.6 mol/L phosphoric acid to perform a film removing treatment.

Thereafter, the aluminum substrate was subjected to a re-anodization treatment for 5 hours using an electrolytic solution of 0.50 mol/L oxalic acid under conditions of a voltage of 40 V, a liquid temperature of 16° C., and a liquid flow rate of 3.0 m/min to obtain an anodized film having a film thickness of 40 μm.

Furthermore, in the pre-anodization treatment and the re-anodization treatment, a stainless steel electrode was used as a cathode, and GP0110-30R (manufactured by TAKASAGO Ltd.) was used as a power source. In addition, NeoCool BD36 (manufactured by Yamato Scientific Co., Ltd.) was used as a cooling device, and PAIRSTIRRER PS-100 (manufactured by Tokyo Rikakikai Co., Ltd.) was used as a stirring and heating device. Furthermore, a flow rate of the electrolytic solution was measured using a vortex flow monitor FLM22-10PCW (manufactured by AS ONE Corporation).

### <Metal Filling Step>

Next, the aluminum substrate was used as a cathode and platinum was used as a positive electrode for an electrolytic plating treatment.

Specifically, a copper plating liquid having the composition shown below was used, and constant current electrolysis was carried out to produce a metal-filled microstructure in which copper was filled inside the pores (micropores).

Here, for the constant current electrolysis, a plating device manufactured by YAMAMOTO-MS Co., Ltd. was used, and a power source (HZ-3000) manufactured by HOKUTO DENKO Corporation was used, cyclic voltammetry was carried out in the plating liquid, and then after checking precipitation potential, the treatment was carried out under the conditions shown below.

### (Composition of Copper Plating Liquid and Conditions)

| | | |
|---|---|---|
| Copper sulfate | 100 | g/L |
| Sulfuric acid | 50 | g/L |
| Hydrochloric acid | 15 | g/L |
| Temperature | 25° | C. |
| Current density | 10 | A/dm² |

A surface of the anodized film after filling the pores with the metal was observed with FE-SEM, and in a case where the presence or absence of sealing with the metal in 1,000 pores was observed to calculate a sealing rate (the number of pores to be sealed/1,000), which was found to be 96%.

In addition, the anodized film after filling the pores with the metal was cut with FIB in the thickness direction, and a surface photograph (magnification: 50,000 times) of a cross-section thereof was taken with FE-SEM to confirm the inside of the pores. Thus, it was found that the filling height from the bottom of the pores was 35 μm.

### <Plate Removing Step>

Next, the aluminum substrate was dissolved by being immersed in a 0.5%-by-weight aqueous Cu-12% HCl solution at 10° C. for 1 hour, and removed.

Thereafter, the anodized film was dissolved by being immersed in an aqueous potassium hydroxide solution (concentration: 2.5 M) at 35° C. for 60 minutes, and removed to obtain an acicular metal.

### <Reduction or Removal Step>

Next, the surface oxide layer of the acicular metal was reduced or removed by being immersed in a 10%-by-weight aqueous sulfuric acid solution at 35° C. for 15 seconds.

### <Recovery>

Next, the acicular metal was recovered by suction filtration using a membrane (0.4 μm, PTFE, manufactured by Omnipore).

### <Washing/Protective Layer Forming Step>

Next, the acicular metal recovered on the membrane was washed for 5 minutes using a washing solvent shown below. Furthermore, in Example 1, a protective layer was formed at the same time as the washing since a corrosion inhibitor was added to the washing solvent.

Then, the metal nanowire on the membrane was recovered and dried under reduced pressure for 12 hours.

### (Washing Solvent)

An aqueous solution containing 1% by mass of each of citric acid and benzotriazole

### Examples 2 to 9

Metal nanowires were recovered by the same method as in Example 1, except that a washing solvent in which the type of a corrosion inhibitor was changed to that shown in Table 1 below was used. Furthermore, washing solvents used in Examples 6 to 9 are as follows.

Example 6: An aqueous solution containing 1% by mass of nitrilotriacetic acid

Example 7: An aqueous solution containing 1% by mass of citric acid

Example 8: An aqueous solution containing 1% by mass of uric acid and 2% by mass of ethanolamine

Example 9: An aqueous solution containing 1% by mass of gallic acid

### Examples 10 and 11

Metal nanowires were recovered by the same method as in Example 1, except that the type of a metal to be used in the metal filling step was changed to that shown in Table 1 below.

### Example 12

A metal nanowire was recovered by the same method as in Example 1, except that the “electrolytic plating treatment” in the metal filling step was changed to an “electroless plating treatment” performed under the copper plating liquid composition and conditions shown below.

### <Composition of Copper Plating Liquid and Conditions>

| | | |
|---|---|---|
| Copper sulfate | 15 | g/L |
| Formalin | 3.5 | g/L |
| Tetrasodium ethylenediamine tetraacetate | 30 | g/L |
| NaOH | 8 | g/L |
| Temperature | 60° | C. |
| Time | 180 | min |

### Example 13

A metal nanowire was recovered by the same method as in Example 1, except that the solution used for dissolving the aluminum substrate was changed to a “200 g/L aqueous sodium hydroxide solution at 20° C.”.

### Example 14

A metal nanowire was recovered by the same method as in Example 1, except that the protective layer forming step was performed after washing the acicular metal.

Specifically, the acicular metal recovered on the membrane was washed with pure water for 5 minutes, and then the acicular metal was recovered.

Next, the recovered acicular metal was immersed in “50 cc of an aqueous solution containing 1% by mass of each of citric acid and benzotriazole (BTA)”.

Then, the metal nanowire was recovered using filter paper and dried under reduced pressure for 12 hours.

### Example 15

A metal nanowire was recovered by the same method as in Example 1, except that in the metal filling step, the time of the electrolytic plating treatment was changed and the filling height from the bottom of the pore was set to 40 μm (that is, the inside of the pore was completely filled with the metal).

### Example 16

A metal nanowire was recovered by the same method as in Example 1, except that the thickness of the anodized film formed in the anodization step was changed to 100 μm and the filling height of the metal filled in the metal filling step was changed to 80 μm.

### Example 17

A metal nanowire was recovered by the same method as in Example 1, except that the thickness of the anodized film formed in the anodization step was changed to 10 μm and the filling height of the metal filled in the metal filling step was changed to 7 μm.

### Example 18

A metal nanowire was recovered by the same method as in Example 1, except that the electrolytic solution used in the anodization step was changed to an “electrolytic solution of 0.55 mol/L sulfuric acid”.

### Example 19

A metal nanowire was recovered by the same method as in Example 1, except that the solution used for removing the anodized film was changed to an “aqueous solution (60° C.) of 12% by mass of phosphoric acid and 4% by mass of chromic acid”.

### Example 20

A metal nanowire was recovered by the same method as in Example 1, except that for the method for recovering the acicular metal, centrifugation was performed at 50,000 rpm for 20 minutes using a centrifuge (Himac CS150FNX) instead of the recovery by the membrane. Furthermore, after the centrifugation, a solid content (acicular metal) was scraped off, recovered, and dried.

### Example 21

A metal nanowire was recovered by the same method as in Example 1, except that the following washing solvent was used.

Washing solvent: Propan-2-one containing 1% by mass of benzotriazole

### Example 22

A metal nanowire was recovered by the same method as in Example 1, except that for the removal of the aluminum substrate, polishing was performed under the following conditions using a cast polishing machine.

### <Polishing Conditions>

Polishing agent: Alumina slurry #400
Pressurization: 0.2 MPa
Time: 20 minutes

### Example 23

A metal nanowire was recovered by the same method as in Example 1, except that the reduction or removal step was not carried out.

### Comparative Example 1

A metal nanowire was recovered by the same method as in Example 1, except that the washing/protective layer forming step was changed to a “displacement plating treatment” described below and displacement plating of nickel was performed without forming the protective layer.

### <Displacement Plating Treatment>

Next, the acicular metal recovered on the membrane was immersed in a 5-fold diluted solution (25° C.) of ICP ACCERA manufactured by OKUNO Chemical Industries Co., Ltd. for 30 seconds and then immersed in a 5-fold diluted solution of TOP CHEM ALLOY 66-LF (60° C.) for 10 seconds to perform displacement plating of nickel.

### Evaluations

For the recovered metal nanowires, evaluations as shown below were performed. The results are shown in Table 1 below.

### Time

The time required from the start of the metal filling step to the recovery of the metal nanowire was measured and evaluated in accordance with the following standard.

### <Evaluation Standard>

A: The time is within 100 minutes.
B: The time is more than 100 minutes and 200 minutes or less.
C: The time is more than 200 minutes.

### Temporal Stability

The recovered metal nanowires were stored in a vacuum desiccator, and the metal nanowires at a timing after the lapse of 2 weeks and 1 month were measured by X-ray photoelectron spectroscopy (XPS) (AlKa rays, beams at 100 μmo, Fi-Quantum 5000), and evaluated in accordance with the following standard.

### <Evaluation Standard>

A: Non-oxidized copper was detected in the product after the lapse of one month.
B: Non-oxidized copper was detected in the product after the lapse of two months, but non-oxidized copper was not detected the product after the lapse of one month.
C: Non-oxidized copper was detected in the product after the lapse of two months.

### Connection Resistance

An isobutanol mixed solution containing 5 mg/mL of the recovered metal nanowires was prepared, and then mixed and dispersed for 3 hours using a bead mill (zirconia beads having a diameter of 0.3 mm) to prepare a dispersion liquid.

The prepared dispersion liquid was applied onto a Ti foil (50 mm×50 mm) using a metal mask (opening portion: 10×6.5 mm×0.15 mm) and dried in a nitrogen atmosphere at 80° C. for 20 minutes.

Next, the application and the drying were repeated 10 times.

Thereafter, heating and pressurization were performed at 50 MPa and 250° C. for 30 minutes under vacuum.

Next, the Ti foil was peeled off to isolate a sintered body.

Next, the connection resistance was measured using LORESTA GP manufactured by Dia Instruments Co., Ltd. by setting a distance between measurement terminals (pins) to 1 mm and a pressing pressure (spring pressure) of the measurement terminals to 200 g.

### <Evaluation Standard>

A: The connection resistance is 150% or less with respect to the resistance of copper.
B: The connection resistance is more than 150% and 200% or less with respect to the resistance of copper.
C: The connection resistance is more than 200% with respect to the resistance of copper.

TABLE 1

| | | | | | | Removal of | | | | |
|---|---|---|---|---|---|---|---|---|---|---|
| | | | Metal filling step | | | valve metal | | | | |
| | Anodization step | | | | Filling | substrate | Removal of anodized film | | | Reduction/removal |
| | Treatment | Thickness | | | height | Treatment | Dissolution | Concentration | Time | Sulfuric acid |
| | liquid | (μm) | Metal | Method | (μm) | liquid | method | (M) | (min) | treatment |
| Example 1 | Oxalic | 40 | Cu | Electrolytic | 35 | Hydrochloric | KOH | 2.5 | 60 | Included |
| | acid | | | plating | | acid | | | | |
| Example 2 | Oxalic | 40 | Cu | Electrolytic | 35 | Hydrochloric | KOH | 2.5 | 60 | Included |
| | acid | | | plating | | acid | | | | |
| Example 3 | Oxalic | 40 | Cu | Electrolytic | 35 | Hydrochloric | KOH | 2.5 | 60 | Included |
| | acid | | | plating | | acid | | | | |
| Example 4 | Oxalic | 40 | Cu | Electrolytic | 35 | Hydrochloric | KOH | 2.5 | 60 | Included |
| | acid | | | plating | | acid | | | | |
| Example 5 | Oxalic | 40 | Cu | Electrolytic | 35 | Hydrochloric | KOH | 2.5 | 60 | Included |
| | acid | | | plating | | acid | | | | |
| Example 6 | Oxalic | 40 | Cu | Electrolytic | 35 | Hydrochloric | KOH | 2.5 | 60 | Included |
| | acid | | | plating | | acid | | | | |
| Example 7 | Oxalic | 40 | Cu | Electrolytic | 35 | Hydrochloric | KOH | 2.5 | 60 | Included |
| | acid | | | plating | | acid | | | | |
| Example 8 | Oxalic | 40 | Cu | Electrolytic | 35 | Hydrochloric | KOH | 2.5 | 60 | Included |
| | acid | | | plating | | acid | | | | |
| Example 9 | Oxalic | 40 | Cu | Electrolytic | 35 | Hydrochloric | KOH | 2.5 | 60 | Included |
| | acid | | | plating | | acid | | | | |
| Example 10 | Oxalic | 40 | Au | Electrolytic | 35 | Hydrochloric | KOH | 2.5 | 60 | Included |
| | acid | | | plating | | acid | | | | |
| Example 11 | Oxalic | 40 | Ni | Electrolytic | 35 | Hydrochloric | KOH | 2.5 | 60 | Included |
| | acid | | | plating | | acid | | | | |
| Example 12 | Oxalic | 40 | Cu | Electroless | 40 | Hydrochloric | KOH | 2.5 | 60 | Included |
| | acid | | | plating | | acid | | | | |
| Example 13 | Oxalic | 40 | Cu | Electrolytic | 35 | NaOH | KOH | 2.5 | 60 | Included |
| | acid | | | plating | | | | | | |
| Example 14 | Oxalic | 40 | Cu | Electrolytic | 35 | Hydrochloric | KOH | 2.5 | 60 | Included |
| | acid | | | plating | | acid | | | | |
| Example 15 | Oxalic | 40 | Cu | Electrolytic | 40 | Hydrochloric | KOH | 2.5 | 60 | Included |
| | acid | | | plating | | acid | | | | |
| Example 16 | Oxalic | 100 | Cu | Electrolytic | 80 | Hydrochloric | KOH | 2.5 | 60 | Included |
| | acid | | | plating | | acid | | | | |
| Example 17 | Oxalic | 10 | Cu | Electrolytic | 7 | Hydrochloric | KOH | 2.5 | 60 | Included |
| | acid | | | plating | | acid | | | | |
| Example 18 | Sulfuric | 40 | Cu | Electrolytic | 35 | Hydrochloric | KOH | 2.5 | 60 | Included |
| | acid | | | plating | | acid | | | | |
| Example 19 | Oxalic | 40 | Cu | Electrolytic | 35 | Hydrochloric | Chromic | 2.0 | 60 | Included |
| | acid | | | plating | | acid | acid | | | |
| Example 20 | Oxalic | 40 | Cu | Electrolytic | 35 | Hydrochloric | KOH | 2.5 | 60 | Included |
| | acid | | | plating | | acid | | | | |
| Example 21 | Oxalic | 40 | Cu | Electrolytic | 35 | Hydrochloric | KOH | 2.5 | 60 | Included |
| | acid | | | plating | | acid | | | | |
| Example 22 | Oxalic | 40 | Cu | Electrolytic | 35 | Polishing | KOH | 2.5 | 60 | Included |
| | acid | | | plating | | | | | | |
| Example 23 | Oxalic | 40 | Cu | Electrolytic | 35 | Hydrochloric | KOH | 2.5 | 60 | Not included |
| | acid | | | plating | | acid | | | | |
| Comparative | Oxalic | 40 | Cu | Electrolytic | 35 | Hydrochloric | KOH | 2.5 | 60 | Included |
| Example 1 | acid | | | plating | | acid | | | | |

| | | Washing/protective layer forming step | | | | | | | |
|---|---|---|---|---|---|---|---|---|---|
| | | | | | Method | | | | |
| | | | | | for adding | | Evaluation | | |
| | Recovery | Washing | | | corrosion | Surface | | Temporal | Connection |
| | Method | solvent | Corrosion inhibitor | | inhibitor | coating | Time | stability | resistance |
| Example 1 | Membrane | Water | Citric acid | Benzotriazole | Added to | — | A | A | A |
| | | | | | washing | | | | |
| | | | | | solvent | | | | |
| Example 2 | Membrane | Water | Citric acid | Tolyltriazole | Added to | — | A | A | A |
| | | | | | washing | | | | |
| | | | | | solvent | | | | |
| Example 3 | Membrane | Water | Citric acid | Mercaptobenzothiazole | Added to | — | A | A | A |
| | | | | | washing | | | | |
| | | | | | solvent | | | | |
| Example 4 | Membrane | Water | Citric acid | Imidazole | Added to | — | A | A | A |
| | | | | | washing | | | | |
| | | | | | solvent | | | | |
| Example 5 | Membrane | Water | Citric acid | Dimethylmercaptothiadiazole | Added to | — | A | A | A |
| | | | | | washing | | | | |
| | | | | | solvent | | | | |
| Example 6 | Membrane | Water | Nitril otriacetic | — | Added to | — | A | A | A |
| | | | acid | | washing | | | | |
| | | | | | solvent | | | | |
| Example 7 | Membrane | Water | Citric acid | — | Added to | — | A | B | A |
| | | | | | washing | | | | |
| | | | | | solvent | | | | |
| Example 8 | Membrane | Water | Uric acid | Ethanolamine | Added to | — | A | B | A |
| | | | | | washing | | | | |
| | | | | | solvent | | | | |
| Example 9 | Membrane | Water | Gallic acid | — | Added to | — | A | B | A |
| | | | | | washing | | | | |
| | | | | | solvent | | | | |
| Example 10 | Membrane | Water | Citric acid | Benzotriazole | Added to | — | A | A | A |
| | | | | | washing | | | | |
| | | | | | solvent | | | | |
| Example 11 | Membrane | Water | Citric acid | Benzotriazole | Added to | — | A | A | B |
| | | | | | washing | | | | |
| | | | | | solvent | | | | |
| Example 12 | Membrane | Water | Citric acid | Benzotriazole | Added to | — | A | A | B |
| | | | | | washing | | | | |
| | | | | | solvent | | | | |
| Example 13 | Membrane | Water | Citric acid | Benzotriazole | Added to | — | A | A | A |
| | | | | | washing | | | | |
| | | | | | solvent | | | | |
| Example 14 | Membrane | Water | Citric acid | Benzotriazole | Added | — | A | B | B |
| | | | | | after | | | | |
| | | | | | washing | | | | |
| Example 15 | Membrane | Water | Citric acid | Benzotriazole | Added to | — | B | A | A |
| | | | | | washing | | | | |
| | | | | | solvent | | | | |
| Example 16 | Membrane | Water | Citric acid | Benzotriazole | Added to | — | B | A | A |
| | | | | | washing | | | | |
| | | | | | solvent | | | | |
| Example 17 | Membrane | Water | Citric acid | Benzotriazole | Added to | — | B | A | A |
| | | | | | washing | | | | |
| | | | | | solvent | | | | |
| Example 18 | Membrane | Water | Citric acid | Benzotriazole | Added to | — | A | A | B |
| | | | | | washing | | | | |
| | | | | | solvent | | | | |
| Example 19 | Membrane | Water | Citric acid | Benzotriazole | Added to | — | A | A | A |
| | | | | | washing | | | | |
| | | | | | solvent | | | | |
| Example 20 | Centrifugation | Water | Citric acid | Benzotriazole | Added to | — | B | A | A |
| | | | | | washing | | | | |
| | | | | | solvent | | | | |
| Example 21 | Membrane | Propan- | Benzotriazole | — | Added to | — | A | B | A |
| | | 2-one | | | washing | | | | |
| | | | | | solvent | | | | |
| Example 22 | Membrane | Water | Citric acid | Benzotriazole | Added to | — | B | A | A |
| | | | | | washing | | | | |
| | | | | | solvent | | | | |
| Example 23 | Membrane | Water | Citric acid | Benzotriazole | Added to | — | A | A | B |
| | | | | | washing | | | | |
| | | | | | solvent | | | | |
| Comparative | Membrane | (Displacement plating) | | | | Ni | C | C | C |
| Example 1 | | | | | | coating | | | |

From the results shown in Table 1, it was found that in a case where a protective layer containing a corrosion inhibitor is not formed, the connection resistance is increased (Comparative Example 1).

On the other hand, it was found that in a case where a protective layer containing a corrosion inhibitor is formed on the acicular metal, the connection resistance is lowered, and the temporal stability and the temporal stability can be maintained at the same level as in Comparative Example 1 (Examples 1 to 23).

In particular, from the comparison between Example 1 and Example 23, it was found that a metal nanowire with a lower connection resistance can be obtained in a case where a step of reducing or removing the surface oxide layer of the acicular metal is provided between the mold removing step and the protective layer forming step.

Furthermore, from the comparison between Examples 1 to 5 and Examples 6 to 9, it was found that in a case where the corrosion inhibitor includes a nitrogen-containing compound, the temporal stability is improved.

Moreover, from the comparison between Example 1 and Example 11, it was found that in a case where the filling metal is Cu, the connection resistance is further reduced, as compared with Ni.

Furthermore, from the comparison between Example 1 and Example 14, it was found that in a case where a protective layer is formed at the same time as washing the acicular metal, the temporal stability is improved and the connection resistance is further reduced.

In addition, from the comparison between Example 1 and Example 18, it was found that in a case where the electrolytic solution in the anodization step is oxalic acid, the connection resistance is further reduced.

In addition, with regard to the metal nanowire recovered in Example 1, the above-described evaluation on the connection resistance was also performed in a system in which conductive particles were blended, as described below.

Specifically, the connection resistance was evaluated by the same method as in Example 1, except that the amount of the metal nanowire recovered in Example 1 was set to 4 mg/mL and a dispersion liquid to which 1 mg/mL of a wet copper powder “1300Y” (particle size distribution (D50): 3.5 μm) manufactured by Mitsui Mining & Smelting Co., Ltd. had been further added was used, and the evaluation result was A.

Furthermore, the connection resistance was evaluated by the same method as in Example 1, except that the amount of the metal nanowire of Example 1 was set to 4 mg/mL and a dispersion liquid to which 1 mg/mL of flaky copper powder “1200YP” (particle size distribution (D50): 3.1 μm) manufactured by Mitsui Mining & Smelting Co., Ltd. had been further added was used, and the evaluation result was A.

In addition, the connection resistance was evaluated by the same method as in Example 1, except that the amount of the metal nanowire of Example 1 was set to 4 mg/mL and a dispersion liquid to which 1 mg/mL of fine particle copper powder “MA-CJU” (particle size distribution (D50): 17.7 μm) manufactured by Mitsui Mining & Smelting Co., Ltd. had been further added was used, and the evaluation result was B.

### EXPLANATION OF REFERENCES

1: valve metal substrate
2: pore (micropore)
3: anodized film
4: metal
5: acicular metal
6: protective layer
10: metal nanowire

What is claimed is:

1. A method for producing a metal nanowire, the method comprising:
an anodization step of forming an anodized film having pores on a surface of a valve metal substrate;
a metal filling step of filling the pores with a metal;
a mold removing step of removing the anodized film and the valve metal substrate to obtain an acicular metal; and
a protective layer forming step of forming a protective layer containing a corrosion inhibitor on the acicular metal.

2. The method for producing a metal nanowire according to claim 1, further comprising, between the mold removing step and the protective layer forming step:
a step of reducing or removing a surface oxide layer of the acicular metal.

3. The method for producing a metal nanowire according to claim 1,
wherein the valve metal substrate includes aluminum.

4. The method for producing a metal nanowire according to claim 1,
wherein the metal filling step includes a plating step.

5. The method for producing a metal nanowire according to claim 1,
wherein the mold removing step includes a two-stage removal step of removing the valve metal substrate and then removing the anodized film.

6. The method for producing a metal nanowire according to claim 1,
wherein the mold removing step includes a dissolution step.

7. The method for producing a metal nanowire according to claim 1,
wherein filling with the metal in the metal filling step is a treatment performed on a region from a bottom of the pore to a middle of an opening portion out of an entire region from the bottom of the pore to the opening portion.

8. The method for producing a metal nanowire according to claim 1,
wherein the corrosion inhibitor includes a heterocyclic compound containing at least one of a nitrogen atom or a sulfur atom.

9. The method for producing a metal nanowire according to claim 1,
wherein the corrosion inhibitor includes at least one of a polar group-containing acid or a polar group-containing base.

10. The method for producing a metal nanowire according to claim 1,
wherein the corrosion inhibitor includes a carboxy group.

11. A metal nanowire comprising:
an acicular metal; and
a protective layer covering at least a part of the acicular metal,
wherein the protective layer contains a corrosion inhibitor.

12. A dispersion liquid comprising:
the metal nanowire according to claim 11.

13. The dispersion liquid according to claim 12,
wherein the dispersion liquid is used in a conductive ink application.

14. A conductive film formed of the dispersion liquid according to claim 12.

15. The conductive film according to claim 14,
wherein the conductive film is used in a transparent conductive film application.

16. The method for producing a metal nanowire according to claim 2,
wherein the valve metal substrate includes aluminum.

17. The method for producing a metal nanowire according to claim 2,
wherein the metal filling step includes a plating step.

18. The method for producing a metal nanowire according to claim 2,
wherein the mold removing step includes a two-stage removal step of removing the valve metal substrate and then removing the anodized film.

19. The method for producing a metal nanowire according to claim 2,
wherein the mold removing step includes a dissolution step.

20. The method for producing a metal nanowire according to claim 2,
wherein filling with the metal in the metal filling step is a treatment performed on a region from a bottom of the pore to a middle of an opening portion out of an entire region from the bottom of the pore to the opening portion.
